(19) United States
(12) Patent Application Publication
(10) Pub. No.: US 2008/0259079 A1
(43) Pub. Date: Oct. 23, 2008

(54) Method and system for volume rendering

(76) Inventors: Benjamin D. Boxman, Herzlya (IL); Erez Doron, Tel Aviv (IL)

Correspondence Address: NATH & ASSOCIATES, 112 South West Street, Alexandria, VA, 22314, US

(21) Appl. No.: 11/785,580

(22) Filed: Apr. 18, 2007

(51) Int. Cl. G06T 17/00

(52) U.S. Cl. 345/424

(57) ABSTRACT

Herewith disclosed a computerized method of volume rendering, a volume rendering tool and a radar imaging system capable of rendering volumetric data. The method of volume rendering comprises obtaining volumetric data represented as a plurality of voxels, sampling the voxels at different resolutions corresponding to the limited number of two-dimensional elements per sample, and compositing the two-dimensional elements in order to calculate values to be assigned to respective pixels for visualization. The compositing comprises generating a data structure associated with the plurality of different-resolution two-dimensional elements and configured to provide a relationship between said plurality and pixels in an image grid, wherein said data structure is configured to simultaneously hold data related to said different-resolution two-dimensional elements.

### FIELD OF THE INVENTION

The invention relates to image processing systems and methods and, more particularly, to systems and methods of volume rendering, facilitating visualization of three-dimensional (3D) data on a two-dimensional (2D) image plane.

### BACKGROUND OF THE INVENTION

Volume rendering is an important aspect of imaging systems. Volumetric data may be produced by a variety of devices as, for example, medical imaging devices, confocal microscopy devices, scientific visualization devices, radars, etc. Rendering of such data on a two-dimensional display is desirable to make use of data. Volume rendering is a technique used for the visualization (displaying, printing, etc.) of a 2D projection of a volumetric dataset received as a result of volume scanning, sampling and/or otherwise modeling, resulting in 3D discrete data.

Typically, volumetric data involve a very large number of data values, and their rendering demands significant processing power and memory. In many cases the rendering is provided with the help of dedicated hardware (e.g. graphics cards) capable of rendering large amounts of volumetric data.

The problem of effective rendering with lower computational costs and/or improved memory performance has been recognized in prior art and various systems have been developed to provide a solution, for example:

U.S. Pat. No. 5,684,935 (Demesa et al.) entitled “Rendering and warping image generation system and method” discloses a method and system for generating a plurality of images of a three-dimensional scene from a database and a specified eye point and field of view. The method includes rendering an image frame, and warping the image frame by changing the eye point and field of view. The warping process is continued on the same image frame in accordance with a predetermined criteria, such as an evaluation of the distortion between the initial image displayed and the last image displayed for this image frame. The warping process utilizes convolution to change the eye point and field of view.

U.S. Pat. No. 6,198,428 (Sekine) entitled “A three-dimensionally designed display radar” discloses a three dimension radar display in which a two-dimensional image data and three-dimensionally designed image data are depicted in combination in a video memory by the aid of an image controller, and they are simultaneously depicted on a screen of a display unit.

U.S. Pat. No. 6,304,266 (Li) entitled “Method and apparatus for volume rendering” discloses a volume rendering process wherein each voxel among a plurality of recorded voxels includes an opacity-adjusted value representative of a value of a parameter at a location within the volume adjusted by applying an opacity curve to the value. The process includes partitioning the plurality of voxels among a plurality of slices, each slice corresponds to a respective region of the volume. For each slice, the process apportions the plurality of voxels associated with that slice among a plurality of cells associated with that slice. Each cell corresponds to a respective sub-region of the region associated with that slice. For each cell, the process determines that the cell is nontransparent if more than a predetermined number of the voxels associated with that cell have an opacity-adjusted value greater than a predetermined value, otherwise the cell is determined to be transparent. The process stores a texture value for each voxel for only nontransparent cells and renders the stored texture values.

U.S. Pat. No. 6,353,677 (Pfister et al.) entitled “Rendering objects having multiple volumes and embedded geometries using minimal depth information” discloses a method of rendering an object including multiple volumes and polygons. The method casts a ray through the object for each pixel of an image. Each ray is partitioned into segments according to surfaces of each volume. Color and opacity values are accumulated for each segment of each ray. Starting depths of each segment are merged and sorted, in an ascending order, into a combined depth list. Consecutive pairs of starting depths are taken to perform the following steps until done. A front clip plane and a back clip plane are defined for each pair of starting depths. Polygons between the front clip plane and a next volume surface are composited, voxels between the front clip plane and the back clip plane are composited, and polygons between the next volume surface and the back clip plane are composited.

U.S. Pat. No. 6,891,537 (Bruijns) entitled “Method for volume rendering” discloses a method for rendering of a volume data set on a two dimensional display. According to the method of the invention, gradient vectors of voxel values are computed and are replaced by an index into a gradient look up table, thereby reducing the amount of required memory as well as the number of memory accesses during rendering. For each point on a two-dimensional view plane a ray is cast into the volume. Then the volume data is sampled at discrete sample points along each individual ray. During rendering, eight gradient vectors of the neighboring voxels at each sample location are retrieved from the look up table.

Additional general background on volume rendering is presented in an article by M. Meiβner, H. Pfister, R. Westernann and C. M. Wittenbrink, “Volume Visualization and Volume Rendering Techniques.” In: Tutorials 6, Eurographics 2000, Interlaken (Switzerland), 2000. Further background overview of volume rendering optimization may be found, for example, in article by S. Kilthau and T. Möller, “Splatting Optimizations”, Technical Report, School of Computing Science, Simon Fraser University, (SFUCMPT-04/01-TR2001-02), April 2001.

### SUMMARY OF THE INVENTION

The inventors found that there is a need in the art to provide an efficient rendering of volumetric dataset comprising a large amount of zero-valued (transparent) voxels, in particular, for cases of curvelinear and/or unstructured volumes. Among the advantages of certain aspects of the present invention is facilitating a capability of rendering such a dataset with reduced requirements for processing power and memory (typically with no need for dedicated hardware); facilitating a visualization of the volume provided from a certain configurable angle, position and zoom; support of range-dependable resolution, support of perspective requirements, etc.

In accordance with certain aspects of the present invention, there is provided a computerized method of volume rendering, volume rendering tool and radar imaging system capable of rendering the volumetric data in accordance with the method thereof. The method of volume rendering comprises obtaining volumetric data represented as a plurality of voxels, sampling the voxels at different resolutions corresponding to the limited number of two-dimensional elements per sample, and compositing the two-dimensional elements in order to calculate values to be assigned to respective pixels for visualization. The compositing comprises generating a data structure associated with the plurality of different-resolution two-dimensional elements and configured to provide a relationship between said plurality and pixels in an image grid, wherein said data structure is configured to simultaneously hold data related to said different-resolution two-dimensional elements.

In accordance with other aspects of the present invention there is provided a computerized method of volume rendering comprising:
(a) obtaining volumetric data represented as a plurality of samples, each sample characterized by a value indicative of visual attributes of the sample and its position in a three-dimensional image space;
(b) converting one or more samples to respective sets of two-dimensional elements at an image plane thus giving rise to a plurality of two-dimensional elements, each said element characterized by a shape, a size, a position at the image plane and a value indicative of visual attributes of the element and its depth order among the plurality of two-dimensional elements, said value calculated in accordance with the value of respective sample and its position in the three-dimensional image space; each said set of two-dimensional elements configured to cover a projection of respective sample to the image plane such that at least part of each element is positioned within a boundary of said projection, wherein the numbers of the elements in each said set are limited by certain maximal Nₘₐₓ and minimal Nₘᵢₙ, numbers, and wherein at least two two-dimensional elements among said plurality of two-dimensional elements and characterized by at least partly overlapping position at the image plane are generated with different size thus giving rise to different-resolution two-dimensional elements;
(c) generating a data structure associated with the plurality of two-dimensional elements and configured to provide a relationship between said plurality and pixels in an image grid, wherein said data structure is configured to simultaneously hold data related to said different-resolution two-dimensional elements;
(d) processing the data structure in accordance with certain sequence of associated two-dimensional elements in order to calculate values to be assigned to respective pixels for visualization.

In accordance with further aspects of the present invention, the method further comprises creating a collection of forms, said collection configured to comprise two or more sets of forms of different hierarchical levels, each said form characterized by shape, size and two-dimensional position at the image grid, while the forms comprised in each set are configured to enable tessellated coverage of the image grid, each form comprised in k-level set has two or more corresponding forms in (k+1)-level set configured to enable tessellated covering of said k-level form in a manner substantially matching its boundary, wherein the forms in one of said sets correspond to the pixels of the image grid; and configuring at least one of said sets of two-dimensional elements in a manner that each element in the set is characterized by a form selected from said collection, said form characterizing the shape, the size and the two-dimensional position of the respective element.

In accordance with further aspects of the present invention the data structure is arranged to comprise one or more sub-structures, each sub-structure is configured to hold a certain value and is linked to certain portion of the image grid, said portions constituting a plurality of portions configured in a manner facilitating one-to-one relationship between the portions and the forms in said collection of forms; wherein the association with the plurality of two-dimensional elements is provided in a manner that substantially each two-dimensional element is associated with corresponding sub-structure linked to a portion of the image grid having the same shape, size, position and hierarchical level as the form characterizing said element, thus giving rise to equal-level sub-structures.

In accordance with further aspects of the present invention the processing of the data structure comprises processing the data structure in order to assign accumulated values to respective sub-structures; calculating appropriate values to sub-structures linked to the portions of image grid corresponding to the pixels; and assigning said calculated appropriate values to corresponding pixels thus providing the visual attributes to be visualized.

In accordance with other aspects of the present invention, there is provided a volume-rendering tool comprising:
(a) a data acquisition block configured to obtain volumetric data;
(b) a transformation and classification block operatively coupled to the data acquisition block and configured to transform and classify the volumetric data to the samples with assigned values;
(c) a footprint generator operatively coupled to the transformation and classification block and configured to convert one or more samples to respective sets of two-dimensional elements at an image plane thus giving rise to a plurality of two-dimensional elements, each said element characterized by a shape, a size, a position at the image plane and a value indicative of visual attributes of the element and its depth order among the plurality of two-dimensional elements, said value calculated in accordance with the value indicative visual attributes of respective sample and its position in the three-dimensional image space; each said set of two-dimensional elements configured to cover a projection of respective sample to the image plane such that at least part of each element is positioned within a boundary of said projection, wherein the numbers of the elements in each said set are limited by certain maximal Nₘₐₓ and minimal Nₘᵢₙ numbers, and wherein at least two two-dimensional elements among said plurality of two-dimensional elements and characterized by at least partly overlapping position at the image plane are generated with different size thus giving rise to different-resolution two-dimensional elements;
(d) a compositing block operatively coupled to the footprint generator block and to a data structure manager, said data structure manager configured to generate and manage a data structure associated with the plurality of two-dimensional elements and configured to hold simultaneously data related to said different-resolution two-dimensional elements and to provide a relationship between said plurality and pixels in an image grid; wherein said compositing block is configured to process the data structure in accordance with certain sequence of associated two-dimensional elements in order to calculate values to be assigned to respective pixels for visualization.

The volume rendering tool may further comprise a dictionary operatively coupled to the compositing block and to the footprint generator, wherein said dictionary is configured to maintain a collection of forms, said collection configured to comprise two or more sets of forms of different hierarchical levels, each said form characterized by shape, size and two-dimensional position at the image grid, while the forms comprised in each set are configured to enable tessellated coverage of the image grid, each form comprised in k-level set has two or more corresponding forms in (k+1)-level set configured to enable tessellated covering of said k-level form in a manner substantially matching its boundary, wherein the forms in one of said sets correspond to the pixels of the image grid; and the footprint generator is arranged to configure at least one of said sets of two-dimensional elements in a manner that each element in the set is characterized by a form selected from said collection, said form characterizing the shape, the size and the two-dimensional position of the respective element.

In accordance with further aspects of the present invention, the data structure manager in the volume rendering tool is configured to manage the data structure comprising one or more sub-structures, each sub-structure configured to hold a certain value and linked to certain portion of the image grid, said portions constituting a plurality of portions configured in a manner facilitating one-to-one relationship between the portions and the forms in said collection of forms; wherein the association with the plurality of two-dimensional elements is provided in a manner that substantially each two-dimensional element is associated with corresponding sub-structure linked to a portion of the image grid having the same shape, size, position and hierarchical level as the form characterizing said element.

In accordance with other aspects of the present invention there is provided radar imaging system comprising:
(a) a data acquisition block configured to obtain volumetric data;
(b) a transformation and classification block operatively coupled to the data acquisition block and configured to transform and classify the volumetric data to the samples with assigned values;
(c) a footprint generator operatively coupled to the transformation and classification block and configured to convert one or more samples to respective sets of two-dimensional elements at an image plane thus giving rise to a plurality of two-dimensional elements, each said element characterized by a shape, a size, a position at the image plane and a value indicative of visual attributes of the element and its depth order among the plurality of two-dimensional elements, said value calculated in accordance with the value indicative visual attributes of respective sample and its position in the three-dimensional image space; each said set of two-dimensional elements configured to cover a projection of respective sample to the image plane such that at least part of each element is positioned within a boundary of said projection, wherein the numbers of the elements in each said set are limited by certain maximal Nₘₐₓ and minimal Nₘᵢₙ numbers, and wherein at least two two-dimensional elements among said plurality of two-dimensional elements and characterized by at least partly overlapping position at the image plane are generated with different size thus giving rise to different-resolution two-dimensional elements;
(d) a compositing block operatively coupled to the footprint generator block and to a data structure manager, said data structure manager configured to generate and manage a data structure associated with the plurality of two-dimensional elements and configured to hold simultaneously data related to said different-resolution two-dimensional elements and to provide a relationship between said plurality and pixels in an image grid; wherein said compositing block is configured to process the data structure in accordance with certain sequence of associated two-dimensional elements in order to calculate values to be assigned to respective pixels for visualization.

The radar imaging system may further comprise a dictionary operatively coupled to the compositing block and to the footprint generator, wherein said dictionary is configured to maintain a collection of forms, said collection configured to comprise two or more sets of forms of different hierarchical levels, each said form characterized by shape, size and two-dimensional position at the image grid, while the forms comprised in each set are configured to enable tessellated coverage of the image grid, each form comprised in k-level set has two or more corresponding forms in (k+1)-level set configured to enable tessellated covering of said k-level form in a manner substantially matching its boundary, wherein the forms in one of said sets correspond to the pixels of the image grid; and the footprint generator is arranged to configure at least one of said sets of two-dimensional elements in a manner that each element in the set is characterized by a form selected from said collection, said form characterizing the shape, the size and the two-dimensional position of the respective element.

In accordance with further aspects of the present invention, the data structure manager of the radar imaging system is configured to manage the data structure comprising one or more sub-structures, each sub-structure configured to hold a certain value and linked to certain portion of the image grid, said portions constituting a plurality of portions configured in a manner facilitating one-to-one relationship between the portions and the forms in said collection of forms; wherein the association with the plurality of two-dimensional elements is provided in a manner that substantially each two-dimensional element is associated with corresponding sub-structure linked to a portion of the image grid having the same shape, size, position and hierarchical level as the form characterizing said element.

In accordance with further aspects of the present invention the data structure in the method, the tool and/or the system above may be characterized by different data models (e.g. hierarchical, combination of hierarchical and sequential, etc.). The data structure may be processed in different sequence of associated two-dimensional elements, e.g. in accordance with their depth order, size, level in hierarchical structure, etc. The data structure may be divided in two or more blocks, each one configured to provide the relationship with respective pixels, and the processing of said blocks is provided in parallel.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 illustrates a generalized functional block diagram of an imaging system as known in the art;

FIG. 2 illustrates a generalized flow chart of object-order volume rendering as known in the art;

FIG. 3 illustrates a generalized flow chart of object-order volume rendering in accordance with certain embodiments of the present invention;

FIG. 4 schematically illustrates a sample footprint generation with resolution variable in accordance with certain embodiments of the present invention;

FIG. 5 illustrates a generalized flow-chart of compositing stage in accordance with certain embodiments of the present invention;

FIG. 6 schematically illustrates a data structure adapted to compositing footprints generated with resolution variable in accordance with certain embodiments of the present invention; and

FIG. 7 illustrates a generalized functional block diagram of a volume-rendering tool in accordance with certain embodiments of the present invention.

### DETAILED DESCRIPTION OF EXEMPLARY EMBODIMENTS

In the following detailed description, numerous specific details are set forth in order to provide a thorough understanding of the invention. However, it will be understood by those skilled in the art, that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, “creating”, “generating” or the like, refer to the action and/or processes of a computer or computing system, or processor or similar electronic computing device (including FPGA, ASIC and other electronic computing circuits) that manipulate and/or transform data represented as physical, such as electronic, quantities within the computing system's registers and/or memories into other data, similarly represented as physical quantities within the computing system's memories, registers or other such information storage, transmission or display devices.

Embodiments of the present invention may use terms such as, processor, computer, apparatus, system, sub-system, module, unit, device (in single or plural form) for performing the operations herein. These may be specifically constructed for the desired purposes, or may comprise a general purpose computer selectively activated or reconfigured by a computer program stored in the computer. Such a computer program may be stored in a computer readable storage medium, such as, but not limited to, any type of disk including optical disks, CD-ROMs, flash memory (e.g. Disk-on-Key), magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a computer system bus.

Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

The references cited in the background teach many principles of volume rendering that are applicable to the present invention. Therefore the full contents of these publications are incorporated by reference herein where appropriate for appropriate teachings of additional or alternative details, features and/or technical background.

The term “value” used in this patent specification should be expansively construed to cover any compound value, including, for example, several values and/or their combination.

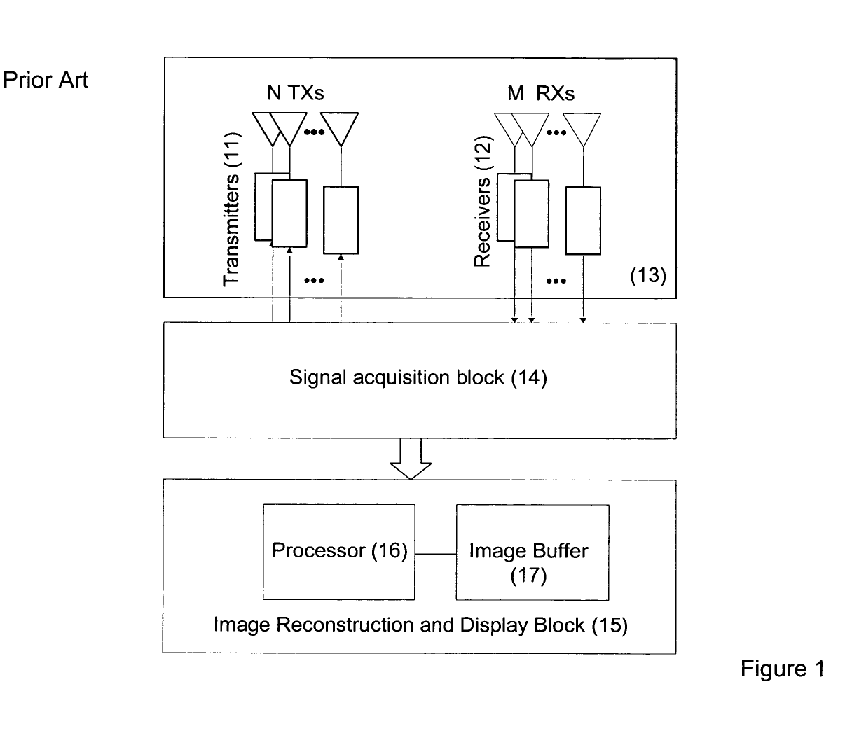

Bearing this in mind, attention is drawn to FIG. 1, illustrating a generalized diagram of an imaging system as known in the art.

For purpose of illustration only, the following description is made with respect to a radar imaging system. Those skilled in the art will readily appreciate that the teachings of the present invention are not bound by radar imaging systems and are applicable in a similar manner to other imaging systems (e.g. MRI devices, ultrasound devices, confocal microscopes, etc.) capable of volume rendering. Likewise, the teachings of the present invention are applicable to a volume-rendering tool facilitating displaying one or more sets of volumetric data obtained from one or more volumetric data inputs. Such tools may be provided stand-alone, in connection or integration with specialized software packages and/or image systems.

The radar imaging system comprises N≧1 transmitters 11 and M≧1 receivers 12 arranged in (or coupled to) an antenna array 13. At least one transmitter transmits a pulse signal (or other form of signal) to a space to be imaged and at least one receiver captures the scattered/reflected waves. To enable high quality imaging, sampling is provided from several receive channels. The process is repeated for each transmitter separately or simultaneously with different coding per each transmitter. The received signals are transferred to a signal acquisition block 14 coupled to the antenna 13.

The resulting signals (typically from all receivers for each transmitter) are transferred to an image reconstruction and display block 15 coupled to the signal acquisition system. The image reconstruction and display block comprises a processor 16 configured to provide computing and data management necessary for volume rendering, said processor coupled to an image buffer 17 configured to accommodate data to be displayed.

Note that the invention is not bound by the radar imaging system described with reference to FIG. 1 and configuration thereof. Those skilled in the art will readily appreciate that equivalent and/or modified functionality may be consolidated or divided in another manner. Those versed in the art will also appreciate that the invention is, likewise, applicable to any other imaging system capable of rendering obtained volumetric data.

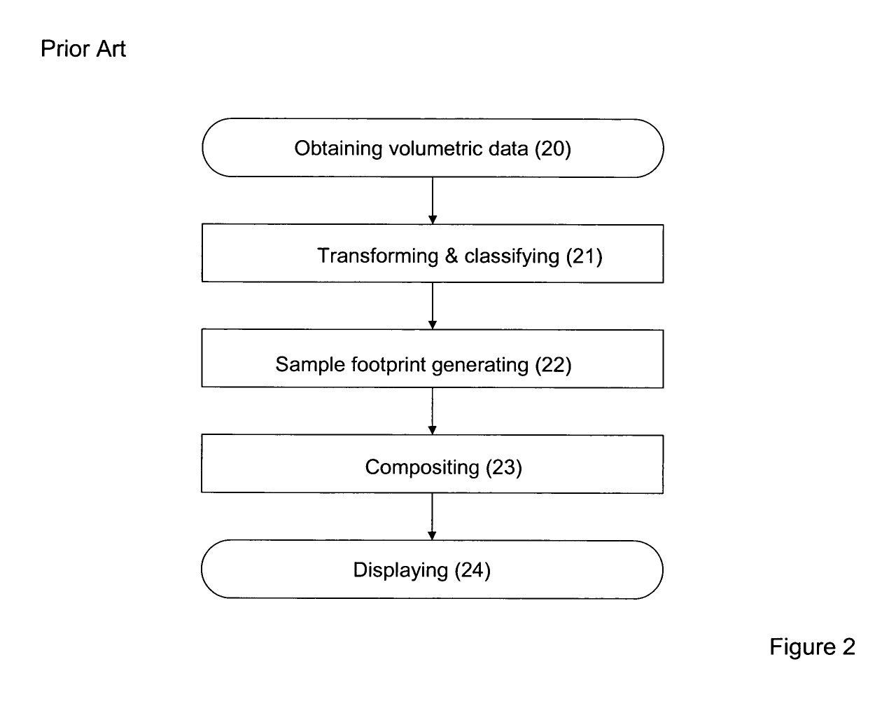

Attention is drawn to FIG. 2, illustrating a generalized flow chart of object-order volume rendering as known in the art.

There are different techniques of volume rendering known in the art; most of them fall into categories of direct volume rendering, surface-fitting rendering, and/or combinations thereof. Surface-fitting rendering typically includes fitting to planar surface primitives such as triangles or polygons in accordance with a predefined or user selected threshold value—the displayed image subsequently displays a single threshold plane. Direct volume rendering methods are characterized by mapping elements directly into a screen space without using geometric primitives for intermediate representation, and include such approaches as object-order (also called projection) methods (e.g. splatting, V-buffer rendering, etc.) and image-order methods (e.g. ray-casting, cell integration, etc.).

A volumetric dataset is commonly represented as a 3D grid of volume elements (voxels). There are several common grids used for volumetric data, e.g. a regular grid consisting of uniformly-spaced sample points located on a rectangular lattice, a curvilinear grid being a regular grid warped with a non-linear transformation so that the sides of each cell need not be straight, an unstructured grid being an arbitrary collection of sample points with no implicit connectivity (although connectivity may be specified explicitly), hybrid grids, in which several different grids are stitched together, etc.

In the projection rendering methods the voxels are processed and projected onto the image plane in the sorted order (e.g. sorted per ascending depth in front-to-back projection or descending depth in back-to-front projection). The typical object-order method of volume rendering comprises the following stages illustrated in FIG. 2: obtaining volumetric dataset (20), transforming and classifying (21), sample footprint generating (22), compositing (23) and visualization (e.g. displaying, providing 2D image for further processing, etc.) (24). The stage (20) of obtaining volumetric dataset may include preparation steps such as presenting the volumetric data as a grid, interpolating missing voxel values, applying image processing operators to improve contrast, classification, etc. The transformation stage comprises transforming a coordinate system of the voxels (also named as an object space) to a corresponding position in the viewing coordinate system (also named as an image space), said transformed voxels referred to hereinafter as “samples”; and sorting the samples in the order of ascending (or descending) depth.

The classification operation may be provided for voxels (e.g. at preparation step) and/or for samples (during or after transformation stage) and comprises assigning respective voxel's visual attributes (e.g. RGBA or other colour scheme value representing colours and opacity/transparency). The colour mapping may be provided, for example, by known scalar visualization techniques (e.g. lookup tables, transfer functions, etc.) that map scalar data (e.g. brightness, intensity, distance, etc.) to colours. The transparency of a colour is represented by the alpha characteristic. An alpha of 0 refers to a completely transparent colour, and an alpha of 1 refers to a completely opaque colour. The voxel list may contain vector data (multiple scalars), and mapping may be multi-dimensional (e.g. the voxels may contain vector information that is already color (+alpha) and the mapping is the identity function).

The transformation stage is followed by the footprint generating stage (22), wherein the footprint represents the contribution of a certain sample to the image plane. This stage comprises converting a sample to a corresponding set of two-dimensional elements in an image plane, said set representing the footprint and referred to hereinafter as a “footprint set”). As known in prior art, elements in different footprint sets are equal and correspond to respective pixels (or a group of pixels), and are characterized by a certain associated value (e.g. related to three-dimensional position and RGBA corresponding to the sample). The RGBA value of the elements in the footprint set may be computed in various ways, some of them known in the art, as, for example, a polygonal approximation of a sample by rasterizing the voxel (i.e. generating a set of elements that are inside the voxel's boundary and setting a constant value for all respective elements); splatting kernels (i.e. by projecting a Gaussian basis function of a voxel to the image plane), etc.

At the compositing stage (23) the footprints corresponding to different samples are blended (e.g. into the image buffer) using either front-to-back or back-to-front compositing, thus providing respective resulting values for the pixels to be visualized (24) (e.g. displayed).

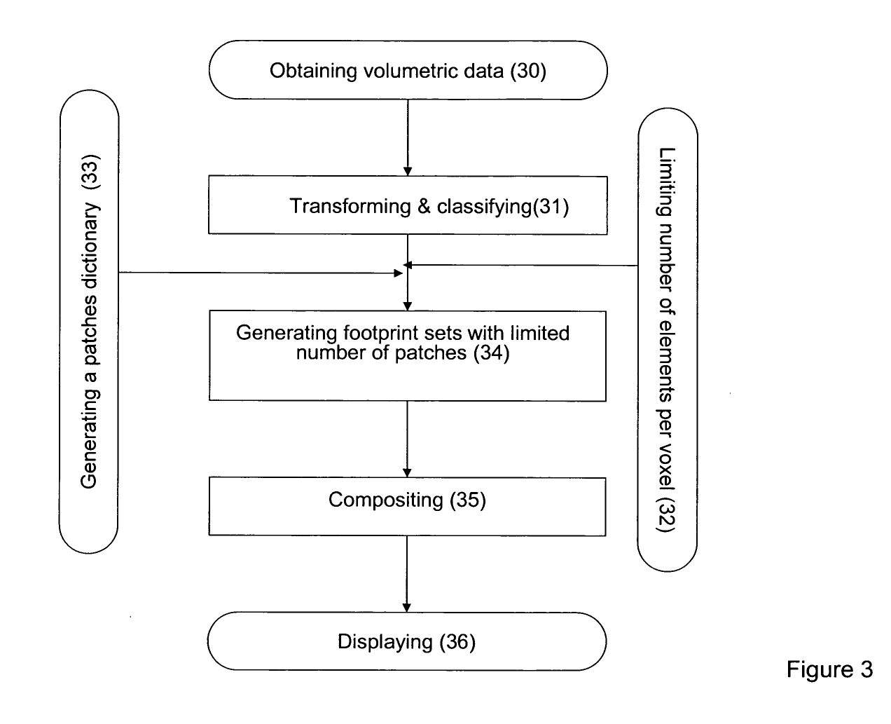

Bearing this in mind, attention is drawn to FIG. 3, illustrating a generalized flow chart of object-order volume rendering in accordance with certain embodiments of the present invention. Similar to the object-order rendering known in the art, the voxels are obtained (30) from the volumetric data, transformed and classified (31) to the samples with assigned values.

The size of voxels and, accordingly, samples, may vary because of different reasons, e.g. non-regular 3D grid, polar coordinates, perspective requirements, etc. In accordance with certain embodiments of the present invention, the number N of elements in different footprint sets generated with regard to different samples is limited (32) by maximal Nₘₐₓ and minimal Nₘᵢₙ numbers, said numbers are predefined and/or configurable, while the elements (referred hereinafter as patches) may vary by size (and/or shape). Thus, in accordance with certain embodiments of the present invention, the voxels are sampled at different resolutions corresponding to the limited number of patches per voxel (sample). In certain embodiments of the invention Nₘₐₓ and Nₘᵢₙ may be defined by dynamic constrains (e.g. related to a number of voxels) or certain covering requirements (e.g. strict fitting a sample's boundary). In certain embodiments Nₘₐₓ may be set to a value approaching infinity and/or Nₘᵢₙ may be set to 1.

A patch is characterized by a shape, a size and an associated value indicative of visual attributes and the three-dimensional position of the patch. In accordance with certain embodiments of the invention, the method comprises creating (33) a collection of forms (optionally including one or more algorithms for generating thereof), said collection is referred hereinafter as a patch dictionary, wherein the form is characterized by shape, size and two-dimensional position at the image grid. The patch dictionary comprises two or more sets of forms of different hierarchical levels. The forms comprised in each set are configured to enable tessellated covering of the image grid, wherein each form of k hierarchical level has two or more corresponding forms of k+1 level configured to enable tessellated covering said k-level form, wherein the tessellated covering is provided in a manner substantially matching the respective boundary. The forms in one of the sets comprised in the patch dictionary correspond to the pixels of the image grid, and the corresponding level is referred to hereinafter as a pixel level. Said patch dictionary may be pre-configured before rendering or generated/modified during the rendering process. It should be noted that, subject to tessellation requirement, the forms in a k-level set may have different size and/or shape.

Accordingly, in accordance with certain embodiments of the present invention, a patch is characterized by a respective form selected from the patch dictionary, said form characterizing the shape, size and two-dimensional position of the patch; by a depth order defined in accordance with patch's position in 3^{rd} dimension and by associated value indicative of visual attributes and calculated in accordance with visual attributes of respective sample. The patch characterized by form comprised in a k-level set is referred to hereinafter as a k-level patch.

Those skilled in the art will readily appreciate that the patch dictionary may comprise forms corresponding to a level beneath the pixel level which may be useful, for example, for cases when voxels are smaller than the end-result pixels on the screen thus preventing aliasing.

Accordingly, during the footprint generation (34) a sample is converted to a set of patches characterized by forms selected from the patch dictionary (or generated in accordance with algorithms thereof), said patches selected in a manner enabling covering of the respective footprint by Nₘₐₓ>N>Nₘᵢₙ patches such that at least part of each patch is positioned within the footprint boundary. The associated values of the patches are calculated in accordance with the value and three-dimensional position of the sample, the calculations may be provided in various ways, e.g. applicable to footprint generation known in the art. It should be noted that certain footprint set may comprise patches characterized by forms of different levels; said patches may cover the respective footprint in a tessellated or overlapped manner.

The patches in the footprint sets of different samples (even congruent samples with different two-dimensional positions) may have different size and/or shape. The size and/or shape of the forms to be selected may be preconfigured or calculated during generation of certain footprints in accordance with one or more algorithms comprised in the patch dictionary.

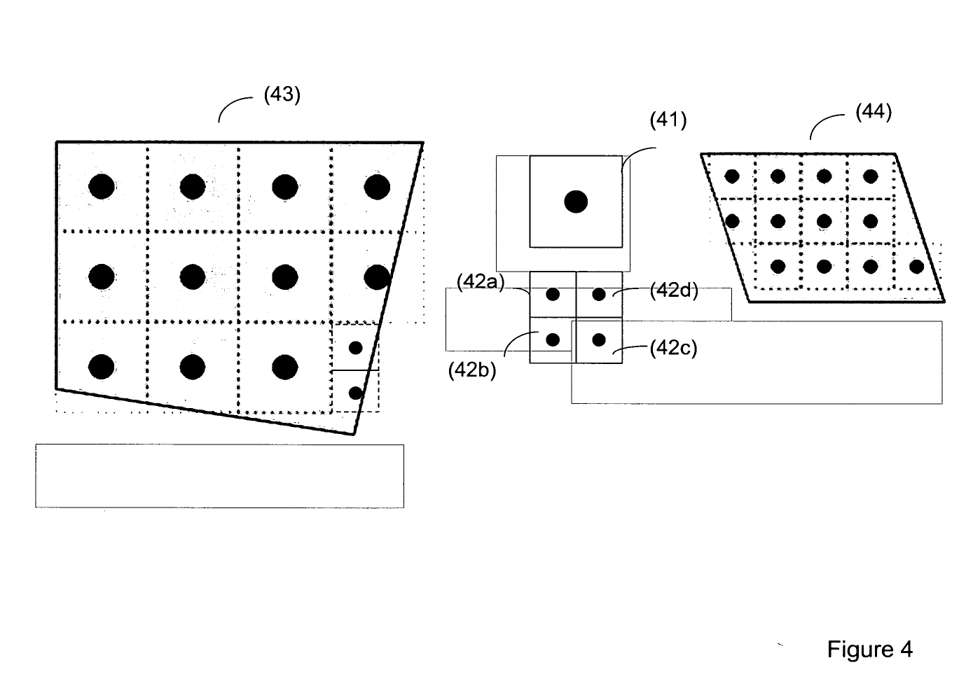

FIG. 4 further details converting the samples to footprints in accordance with certain embodiments of the present invention. By way of non-limiting example, the number N of patches in a footprint set is limited by Nₘₐₓ and Nₘᵢₙ being powers of 4 (e.g. in the illustrated example Nₘₐₓ=16, Nₘᵢₙ=4). The patch dictionary comprises several hierarchical sets of forms, the top level (k=0) set comprises one form covering the rectangle image grid, each (k+1)-level set comprises equal rectangles being divisions into four of k-level rectangles, wherein one of the sets comprises rectangles corresponding to the pixels of the image grid. For example, a large form of k level (41) is divided into four equal smaller forms of (k+1) level (42a-42d).

During the footprint generation the forms of the patches are selected from the patch dictionary in a manner enabling tessellated covering of the respective footprint by 16>N>4 patches. Accordingly, a large sample (43) is represented by eleven large patches characterized by k-level forms and two small patches characterized by (k+1)-level forms, and a small sample (44) is represented by twelve small patches characterized by (k+1)-level forms.

Among considerations for defining the maximal and minimal numbers of patches in the footprint set (Nₘₐₓ and Nₘᵢₙ) is a trade-off between the quality of the resulting image and the amount of computations to be performed. The amount of computations increases linearly with the increase of N, while sampling the footprint is smoother (of higher quality) in proportion to the square root of the N. As was evident in certain embodiments of the present invention, 64>N>16 and even 16>N>4 may provide negligible degradation.

Those skilled in the art will readily appreciate that the invention is not bound by the embodiment described with reference to FIG. 4.

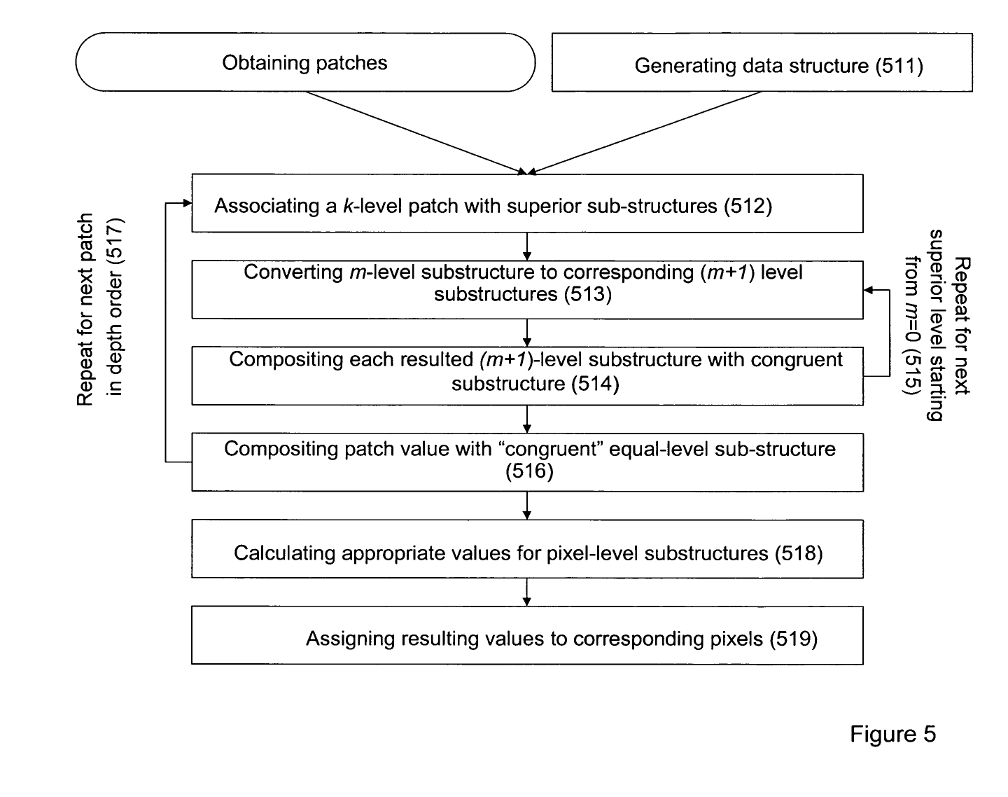

Referring back to FIG. 3, generation of respective footprint sets corresponding to different samples is followed by the compositing stage (35) further detailed with reference to FIG. 5 and comprising calculating respective resulting values for the pixels to be visualized (36).

FIG. 5 illustrates a generalized flow chart of main operations of the compositing stage in accordance with certain embodiments of the present invention. The compositing stage comprises generating (511) a data structure configured to provide a relationship between the generated patches and the pixels in the image grid, thus facilitating calculation of resulting values to be displayed. Said data structure represents two-dimensional data associated with a two-dimensional image grid (e.g. display), and is arranged to comprise one or more sub-structures, each sub-structure is configured to hold a certain value and is linked to certain portion of the image grid. Said portions are configured in a manner facilitating a one-to-one relationship between the portions and the forms in the patch dictionary, each portion having the same shape, size, position and hierarchical level as the corresponding form in the dictionary.

A sub-structure linked to the portion corresponding to a k-level form is referred to hereinafter as a k-level sub-structure. For purpose of illustration only, the following description is made with respect to a one-to-one relationship between sub-structures and portions of the image grid. It should be noted that in certain embodiments of the invention several sub-structures of the same level may be linked to the same portion of the image grid, while holding the same or different values. It should also be noted that the data held by the data structure may be organized in various models, e.g. hierarchical, relational, star, etc.

The data structure is generated in a manner that any k-level patch may be associated with one or more superior sub-structures, an equal-level sub-structure, and one or more inferior sub-structures; wherein the superior sub-structure is a sub-structure of (k−m, m>0) level linked to a portion of image grid covering the patch's position at the image grid, the equal-level sub-structure is a k-level sub-structure linked to a portion of image grid characterized by the same form as the patch, and the inferior sub-structure is a sub-structure of (k+n, n>0) level linked to a portion of image grid covered by the patch's position at the image grid.

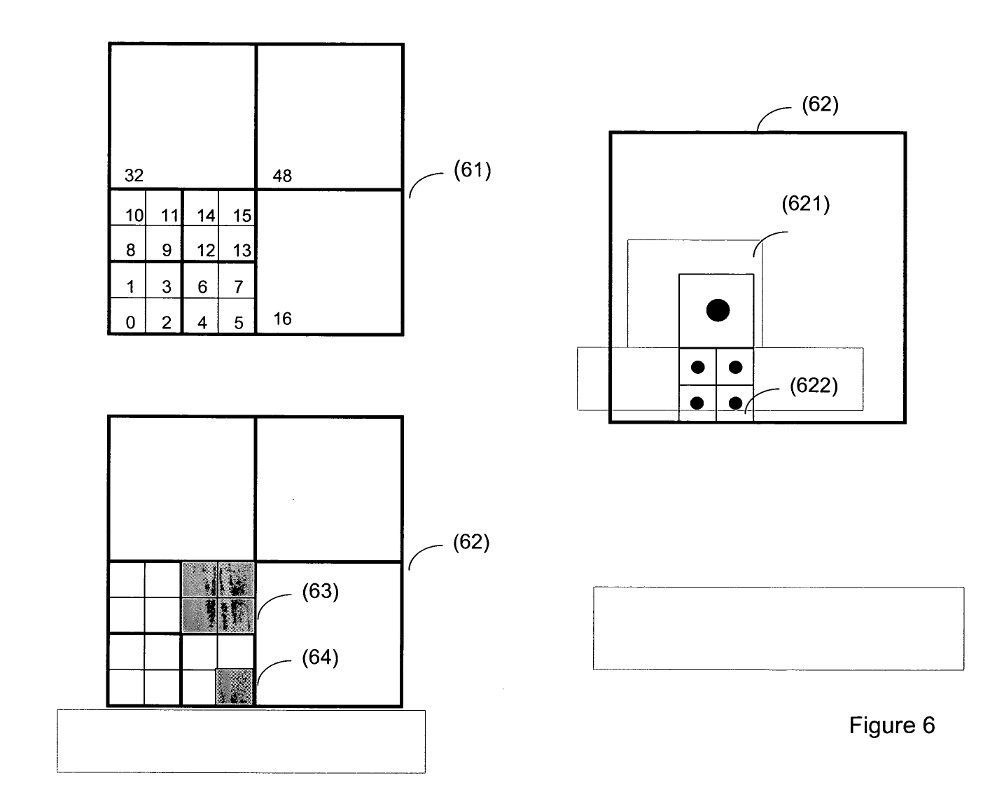

As illustrated by way of non-limiting example in FIG. 6, for the case of patches illustrated with reference to FIG. 4, said data structure may be generated in the form of a quad-tree (61). The quad-tree is known as an adaptation of a binary tree used for representation of two-dimensional (2D) data. In the quad-tree data structure each sub-structure (node) may be recursively subdivided into up to 4 children sub-structures (sub-nodes). The leaf sub-nodes are associated with certain values or other information. In accordance with certain embodiments of the present invention, a node is linked to a certain portion of a two-dimensional image grid (62), the size of said portion depending on the node's level k of hierarchy (k=0 for top level node). Nodes of the same level are linked to congruent rectangular portions covering the image grid in a tessellated manner and characterized by the forms illustrated with reference to FIG. 4. For example, a portion (63) linked to a k-level node is congruent and has the same position as patch (621) characterized by k-level form; a portion (64) linked to (k+1)-level node is congruent and has the same position as the patch (622) characterized by (k+1)-level form. The quad-tree (61) is multi-leveled and may hold a value at any node comprised in the tree, i.e. data related to different resolutions that are held by the same tree including such nodes that are linked to the same portion on the image screen. Likewise, the data structure may be a single level quad-tree (holding values only at the leaf nodes) combined with an external list holding lower-resolution values.

Referring back to FIG. 5, the data structure is processed in sequential depth order of associated patches in order to assign accumulated values to the sub-structures, said accumulated values indicative of contribution of all patches to the corresponding portion of the image grid. The processing may be provided as following:

a) associating a k-level patch with all superior sub-structures (512);

b) converting (513) an m-level sub-structure into a set of (m+1)-level sub-structures linked to the portions of image grid covering the portion of image grid linked to the m-level sub-structure;

c) compositing (514) each sub-structure in said resulting (m+1)-level set with (m+1)-level sub-structure linked to the same portion of the grid (referred to hereinafter as a congruent sub-structure), assigning resulted value to the congruent sub-structure, and setting value of converted m-level sub-structure to zero;

d) repeating (515) the operations c) and d) in a sequential fashion, in ascending order of levels (from m=0 to m=k−1) resulting in calculated “congruent” value of the equal-level sub-structure;

e) compositing (516) the calculated “congruent” value of the equal-level sub-structure with the value of the k-patch, assigning resulted value to said equal-level sub-structure;

f) repeating (517) the operations b)-f) in a sequential depth order for all generated patches thus giving rise to the accumulated values of all respective sub-structures.

Calculating accumulated value for the respective sub-structures may be provided in various ways, some of them depending on a model of data organization in the generated data structure. For example if data structure is represented by a combination of hierarchical data model with sequential data model (e.g. single level quad-tree combined with a list) the described above operations 516 is augmented with an operation (516′) that associates the patch with all inferior sub-structures, and moves said inferior sub-structures values characterizing the high-resolution (small) accumulated patches out of the hierarchical data model into supplementing sequential data model. After repeating the operations (512, 513, 514, 515, 516, 516′) in a sequential depth order for all generated patches, all values held by sub-structures existing in the hierarchical data model are moved into the sequential data model as well, thus the hierarchical data model is cleared. The sub-structures in the sequential data model is then again processed (as if it were the input patch list)—but in the reverse direction (if first pass was front-to-back, then this pass will be back-to-front integration). This continues until the list is empty, and the resulting data in the hierarchical data model represents the accumulated values of all patches.

In certain embodiments of the invention the data structure may be processed in a way other than in sequential depth order of associated patches. For example, in some cases (e.g. in alpha-only or black-and-white rendering for the use of shadow generation and other cases when the result is independent of the processing order), it may be advantageous to provide patch-size sorting.

Following the calculation of the accumulated values of all respective sub-structures, the data structure is further processed in order to calculate (518) appropriate values to pixel-level sub-structures. The processing may be provided as following:

g) all sub-structures in the data-structure, from level 0 to level (p−1), where level p is at the “pixel level” are traversed while providing the following operations:

h) converting an m-level sub-structure into a set of (m+1)-level sub-structures linked to the portions of image grid covering the portion of image grid linked to the m-level sub-structure.

i) compositing each sub-structure in said resulting (m+1) set with (m+1)-level sub-structure linked to the same portion of the grid (referred to hereinafter as a congruent sub-structure), assigning resulted value to the congruent sub-structure;

j) compositing the calculated “congruent” value of the pixel-level sub-structures with initially assigned values of respective sub-structures thus giving rise to resulting values of pixel-level sub-structures.

Said resulting values of pixel-level sub-structures are assigned (519) to corresponding pixels thus providing the visual attributes to be displayed.

If the data-structure contains levels lower than the pixel-level, appropriate values of pixel-level sub-structures may be calculated likewise described with reference to operations g)-i) but in reverse order (from inferior to superior levels), and with an averaging operation that converts the value of a set of (m+1)-level sub-structures to a single m-level value.

As was illustrated above, the value of each pixel is a result of compositing operations applied to all sub-structures linked to the portions of the image grid comprising certain pixels.

Those skilled in the art will readily appreciate that the invention is not bound by the embodiment described with reference to FIGS. 3-6; equivalent and/or modified functionality may be consolidated or divided in another manner. The data structure may be configured in another manner enabling compositing different-resolution patches; calculating resulted value of pixel-level sub-structures may be also provided in various ways.

We may limit the worst-case cost of the compositing stage for certain embodiments of the present invention. By way of non-limiting example, for embodiments illustrated with reference to FIGS. 4 and 6 the worst-case cost of the compositing stage may be estimated as log (D)*(maximal hierarchical level of associated node), where D is one side of the display. An amount of composing operations performed at each level is constant (at most 4 composite operations in said exemplified embodiments). In certain embodiments of the invention the processing includes holding a bit specifying whether the tree is zero valued or not at a given hierarchical level, which may further improve the average case performance for typical volumes.

Since each voxel is represented by a number of nodes limited by a certain constant, the complexity of this stage is: O(V*constant*log(D)), where V is the number of non-zero (visible) voxels among the volumetric data.

Accordingly, among advantages of certain aspects of the invention is facilitating a worst case performance bound of O(V*log(D)+D²) in time and O(V+D̂2) in space. This tight O-bound on the amount of non-zero voxels facilitates the design of hardware, firmware and/or software solutions that meet real-time constraints with relatively low resource consumption requirements (e.g. space on an FPGA, power consumption, CPU time, etc.).

It should be noted that representing the display with several (e.g. 8*8, 16*16, etc.) quad-trees (not-necessary equal) may facilitate reducing the log(D) factor and allows parallelization of the method across different display screen areas. In certain embodiments of the invention the quad-tree may be provided as a pointer-less and be pre-allocated to the size of the display, which provides significant saving in a space overhead.

Because of certain requirements of radar imaging application, the method and system of the present invention may provide significant advantages for such applications, although the implementation is not bound by the radar imaging system. Among said requirements are:
a) Curvilinear nature of the image volume;
b) Utilization of perspective (objects that are further from an observer appear smaller than near objects);
c) Linear decrease of resolution with the range.
d) Large 3D image grid (e.g. Range×Vertical Angle×Horizontal Angle=2000×200×200=100,000,000);
e) The small amount of non-zero voxels in certain radar applications (e.g. in ultra-wide band radars the order of magnitude may be 0.1% of the volume);

etc.

The method and system of the present invention may, likewise, provide significant advantages for applications which comprise displaying the “edges” inside of an image (to quasi-extract surfaces) (e.g. displaying a volume that is the derivative of the original volume as, for example, those portions of the image that have sharp local discontinuities, etc.). This may be used in medical imaging to differentiate between different organs/structures, geological (GPR, or otherwise) representations (e.g. displaying the points where different soil types change) and other inherently sparse applications.

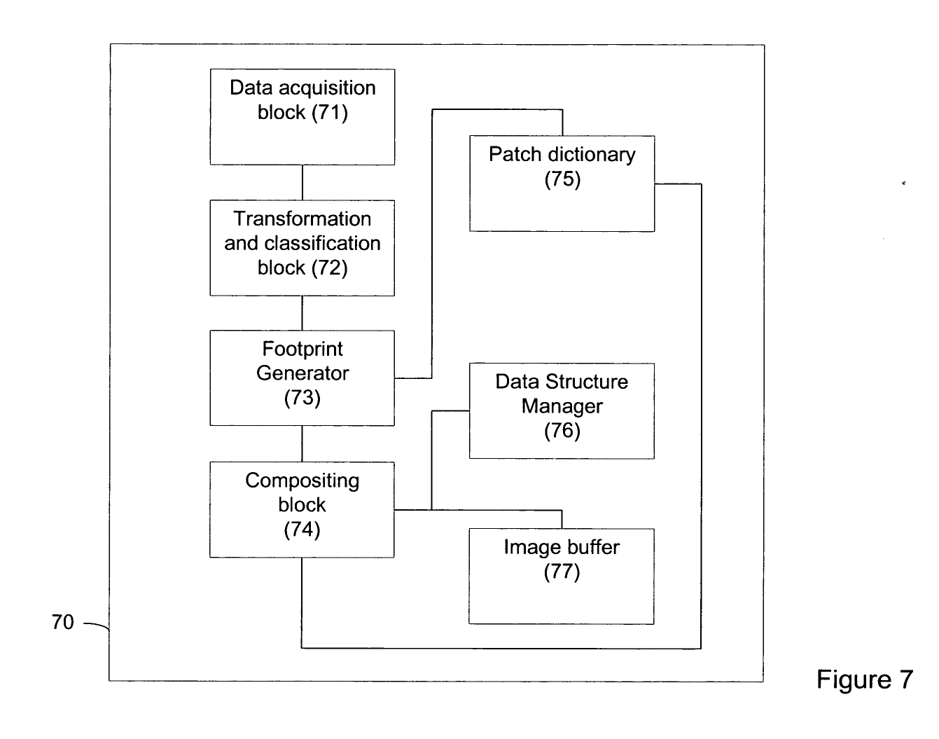

FIG. 7 illustrates a generalized functional block diagram of a volume-rendering tool in accordance with certain embodiments of the present invention. The volume-rendering tool (70) facilitates displaying one or more sets of volumetric data obtained from one or more volumetric data inputs. Such a tool may be provided stand-alone, in connection or integration with specialized software packages and/or image systems. The tool comprises a data acquisition block (71) configured to obtain volumetric data and operatively coupled to a transformation & classification block (72) configured to transform and classify the volumetric data to the samples with assigned values. The transformation & classification block (72) is operatively coupled to a footprint generator (73) configured to provide footprint generation in accordance with embodiments of the present invention described with reference to FIGS. 3-6. The footprint generator is operatively coupled to a patch dictionary (75) and a compositing block (74). The patch dictionary comprises two or more hierarchical sets of forms (optionally including one or more algorithms for generating thereof), said forms detailed with reference to FIGS. 3-6. The compositing block is further operatively coupled to a data structure manager (76) configured to generate and manage the data structure as was detailed with reference to FIGS. 5-6. The compositing block is configured to provide compositing different-resolution patches and calculating the resulted value of a pixel in accordance with embodiments of the present invention detailed with reference to FIGS. 5-6, and to transfer the resulted value to an image buffer (77) operatively coupled to the compositing block and configured to an accommodated pixel's visual attributes to be displayed.

Those skilled in the art will readily appreciate that the system according to the invention, may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

It is also to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception, upon which this disclosure is based, may readily be utilized as a basis for designing other structures, methods, and systems for carrying out the several purposes of the present invention.

Those skilled in the art will readily appreciate that various modifications and changes can be applied to the embodiments of the invention as hereinbefore described without departing from its scope, defined in and by the appended claims.

1. A computerized method of volume rendering comprising:
(a) obtaining volumetric data represented as a plurality of samples, each sample characterized by a value indicative of visual attributes of the sample and its position in a three-dimensional image space;
(b) converting one or more samples to respective sets of two-dimensional elements at an image plane thus giving rise to a plurality of two-dimensional elements, each said element characterized by a shape, a size, a position at the image plane and a value indicative of visual attributes of the element and its depth order among the plurality of two-dimensional elements, said value calculated in accordance with the value of respective sample and its position in the three-dimensional image space; each said set of two-dimensional elements configured to cover a projection of respective sample to the image plane such that at least part of each element is positioned within a boundary of said projection, wherein the numbers of the elements in each said set are limited by certain maximal Nₘₐₓ and minimal Nₘᵢₙ numbers, and wherein at least two two-dimensional elements among said plurality of two-dimensional elements and characterized by at least partly overlapping position at the image plane are generated with different size thus giving rise to different-resolution two-dimensional elements;
(c) generating a data structure associated with the plurality of two-dimensional elements and configured to provide a relationship between said plurality and pixels in an image grid, wherein said data structure is configured to simultaneously hold data related to said different-resolution two-dimensional elements; and
(d) processing the data structure in accordance with certain sequence of associated two-dimensional elements in order to calculate values to be assigned to respective pixels for visualization.

2. The method of claim 1 further comprising:
(a) creating a collection of forms, said collection configured to comprise two or more sets of forms of different hierarchical levels, each said form characterized by shape, size and two-dimensional position at the image grid, while the forms comprised in each set are configured to enable tessellated coverage of the image grid, each form comprised in k-level set has two or more corresponding forms in (k+1)-level set configured to enable tessellated covering of said k-level form in a manner substantially matching its boundary, wherein the forms in one of said sets correspond to the pixels of the image grid; and
(b) configuring at least one of said sets of two-dimensional elements in a manner that each element in the set is characterized by a form selected from said collection, said form characterizing the shape, the size and the two-dimensional position of the respective element.

3. The method of claim 2 wherein the data structure is arranged to comprise one or more sub-structures, each sub-structure is configured to hold a certain value and is linked to certain portion of the image grid, said portions constituting a plurality of portions configured in a manner facilitating one-to-one relationship between the portions and the forms in said collection of forms; wherein the association with the plurality of two-dimensional elements is provided in a manner that substantially each two-dimensional element is associated with corresponding sub-structure linked to a portion of the image grid having the same shape, size, position and hierarchical level as the form characterizing said element, thus giving rise to equal-level sub-structures.

4. The method of claim 3 wherein the processing of the data structure comprises:
(a) processing the data structure in order to assign accumulated values to the sub-structures;
(b) calculating appropriate values to sub-structures linked to the portions of image grid corresponding to the pixels; and
(c) assigning said calculated appropriate values to corresponding pixels thus providing the visual attributes to be visualized.

5. The method of claim 4 wherein
(a) said associating the data structure with the plurality of two-dimensional elements further comprises associating a two-dimensional element with one or more superior sub-structures each one linked to a portion of image grid covering the element's position at the image grid;
(b) said processing the data structure in order to assign accumulated values to the sub-structures comprises:
i) associating a k-level two-dimensional element with all said superior sub-structures;
ii) converting an m-level sub-structure into a set of (m+1)-level sub-structures linked to the portions of image grid covering the portion of image grid linked to the m-level sub-structure;
iii) compositing each sub-structure in said resulting (m+1)-level set with corresponding congruent (m+1)-level sub-structure linked to the same portion of the grid, assigning resulted value to the congruent sub-structure, and setting value of converted m-level sub-structure to zero;
iv) repeating the operations ii) and iii) in a sequential fashion, in ascending order of levels (from m=0 to m=k−1) resulting in calculated a congruent value of the equal-level sub-structure;
v) compositing the calculated congruent value of the equal-level sub-structure corresponding to said k-level two-dimensional element with the value of the k-level two-dimensional element, and assigning the result to the equal-level sub-structure;
vi) repeating the operations i)-v) in a sequential depth order for all elements among the plurality of two-dimensional element thus giving rise to the accumulated values of the respective sub-structures.

6. The method of claim 4 wherein calculating appropriate value to a sub-structure linked to the portion of image grid corresponding to a pixel comprises traversing all said superior sub-structures, said traversing comprising:
(a) converting an m-level sub-structure into a set of (m+1)-level sub-structures linked to the portions of image grid covering the portion of image grid linked to the m-level sub-structure;
(b) compositing each sub-structure in said resulting (m+1) set with corresponding congruent (m+1)-level sub-structure linked to the same portion of the grid and assigning the resulted “congruent” value to the congruent sub-structure; and
(c) compositing the calculated “congruent” value of the sub-structure linked to the pixel with initially assigned values of said sub-structure.

7. The method of claim 1 wherein the data structure is characterized by an hierarchical data model.

8. The method of claim 1 wherein the data structure processing is provided in accordance with depth order of associated two-dimensional elements.

9. The method of claim 1 wherein the data structure is divided in at least two blocks, each one configured to provide the relationship with respective pixels, and the processing of said blocks is provided in parallel.

10. The method of claim 3 wherein the sub-structures are arranged in at least two blocks each one related to respective portion of the image grid, said arrangement provided in a manner that each block comprises sub-structures linked to the portion of the image grid corresponding to the block, and the processing of said blocks is provided in parallel.

11. The method of claim 1 wherein at least one of the two-dimensional elements is characterized by size less than a size of the pixel.

12. A volume-rendering tool comprising:
(a) a data acquisition block configured to obtain volumetric data;
(b) a transformation and classification block operatively coupled to the data acquisition block and configured to transform and classify the volumetric data to the samples with assigned values;
(c) a footprint generator operatively coupled to the transformation and classification block and configured to convert one or more samples to respective sets of two-dimensional elements at an image plane thus giving rise to a plurality of two-dimensional elements, each said element characterized by a shape, a size, a position at the image plane and a value indicative of visual attributes of the element and its depth order among the plurality of two-dimensional elements, said value calculated in accordance with the value indicative visual attributes of respective sample and its position in the three-dimensional image space; each said set of two-dimensional elements configured to cover a projection of respective sample to the image plane such that at least part of each element is positioned within a boundary of said projection, wherein the numbers of the elements in each said set are limited by certain maximal Nₘₐₓ and minimal Nₘᵢₙ numbers, and wherein at least two two-dimensional elements among said plurality of two-dimensional elements and characterized by at least partly overlapping position at the image plane are generated with different size thus giving rise to different-resolution two-dimensional elements; and
(d) a compositing block operatively coupled to the footprint generator block and to a data structure manager, said data structure manager configured to generate and manage a data structure associated with the plurality of two-dimensional elements and configured to hold simultaneously data related to said different-resolution two-dimensional elements and to provide a relationship between said plurality and pixels in an image grid; wherein said compositing block is configured to process the data structure in accordance with certain sequence of associated two-dimensional elements in order to calculate values to be assigned to respective pixels for visualization.

13. The volume rendering tool of claim 12 further comprising a dictionary operatively coupled to the compositing block and to the footprint generator, wherein said dictionary is configured to maintain a collection of forms, said collection configured to comprise two or more sets of forms of different hierarchical levels, each said form characterized by shape, size and two-dimensional position at the image grid, while the forms comprised in each set are configured to enable tessellated coverage of the image grid, each form comprised in k-level set has two or more corresponding forms in (k+1)-level set configured to enable tessellated covering of said k-level form in a manner substantially matching its boundary, wherein the forms in one of said sets correspond to the pixels of the image grid; and the footprint generator is arranged to configure at least one of said sets of two-dimensional elements in a manner that each element in the set is characterized by a form selected from said collection, said form characterizing the shape, the size and the two-dimensional position of the respective element.

14. The volume rendering tool of claim 13 wherein the data structure manager is configured to manage the data structure comprising one or more sub-structures, each sub-structure configured to hold a certain value and linked to certain portion of the image grid, said portions constituting a plurality of portions configured in a manner facilitating one-to-one relationship between the portions and the forms in said collection of forms; wherein the association with the plurality of two-dimensional elements is provided in a manner that substantially each two-dimensional element is associated with corresponding sub-structure linked to a portion of the image grid having the same shape, size, position and hierarchical level as the form characterizing said element.

15. A radar imaging system comprising:
(a) a data acquisition block configured to obtain volumetric data;
(b) a transformation and classification block operatively coupled to the data acquisition block and configured to transform and classify the volumetric data to the samples with assigned values;
(c) a footprint generator operatively coupled to the transformation and classification block and configured to convert one or more samples to respective sets of two-dimensional elements at an image plane thus giving rise to a plurality of two-dimensional elements, each said element characterized by a shape, a size, a position at the image plane and a value indicative of visual attributes of the element and its depth order among the plurality of two-dimensional elements, said value calculated in accordance with the value indicative visual attributes of respective sample and its position in the three-dimensional image space; each said set of two-dimensional elements configured to cover a projection of respective sample to the image plane such that at least part of each element is positioned within a boundary of said projection, wherein the numbers of the elements in each said set are limited by certain maximal Nₘₐₓ and minimal Nₘᵢₙ numbers, and wherein at least two two-dimensional elements among said plurality of two-dimensional elements and characterized by at least partly overlapping position at the image plane are generated with different size thus giving rise to different-resolution two-dimensional elements; and
(d) a compositing block operatively coupled to the footprint generator block and to a data structure manager, said data structure manager configured to generate and manage a data structure associated with the plurality of two-dimensional elements and configured to hold simultaneously data related to said different-resolution two-dimensional elements and to provide a relationship between said plurality and pixels in an image grid; wherein said compositing block is configured to process the data structure in accordance with certain sequence of associated two-dimensional elements in order to calculate values to be assigned to respective pixels for visualization.

16. The radar imaging system of claim 15 further comprising a dictionary operatively coupled to the compositing block and to the footprint generator, wherein said dictionary is configured to maintain a collection of forms, said collection configured to comprise two or more sets of forms of different hierarchical levels, each said form characterized by shape, size and two-dimensional position at the image grid, while the forms comprised in each set are configured to enable tessellated coverage of the image grid, each form comprised in k-level set has two or more corresponding forms in (k+1)-level set configured to enable tessellated covering of said k-level form in a manner substantially matching its boundary, wherein the forms in one of said sets correspond to the pixels of the image grid; and the footprint generator is arranged to configure at least one of said sets of two-dimensional elements in a manner that each element in the set is characterized by a form selected from said collection, said form characterizing the shape, the size and the two-dimensional position of the respective element.

17. The radar imaging system of claim 16 wherein the data structure manager is configured to manage the data structure comprising one or more sub-structures, each sub-structure configured to hold a certain value and linked to certain portion of the image grid, said portions constituting a plurality of portions configured in a manner facilitating one-to-one relationship between the portions and the forms in said collection of forms; wherein the association with the plurality of two-dimensional elements is provided in a manner that substantially each two-dimensional element is associated with corresponding sub-structure linked to a portion of the image grid having the same shape, size, position and hierarchical level as the form characterizing said element.

18. A computerized program storage device readable by machine, tangibly embodying a program of instructions executable by the machine to perform a method of volume rendering comprising
(a) obtaining volumetric data represented as a plurality of samples, each sample characterized by a value indicative of visual attributes of the sample and its position in a three-dimensional image space;
(b) converting one or more samples to respective sets of two-dimensional elements at an image plane thus giving rise to a plurality of two-dimensional elements, each said element characterized by a shape, a size, a position at the image plane and a value indicative of visual attributes of the element and its depth order among the plurality of two-dimensional elements, said value calculated in accordance with the value indicative visual attributes of respective sample and its position in the three-dimensional image space; each said set of two-dimensional elements configured to cover a projection of respective sample to the image plane such that at least part of each element is positioned within a boundary of said projection, wherein the numbers of the elements in each said set are limited by certain maximal Nₘₐₓ and minimal Nₘᵢₙ numbers and wherein at least two two-dimensional elements among said plurality of two-dimensional elements and characterized by at least partly overlapping position at the image plane are generated with different size thus giving rise to different-resolution two-dimensional elements;
(c) generating a data structure associated with the plurality of two-dimensional elements and configured to provide a relationship between said plurality and pixels in an image grid, wherein said data structure is configured to simultaneously hold data related to said different-resolution two-dimensional elements; and
(d) processing the data structure in accordance with certain sequence of associated two-dimensional elements in order to calculate values to be assigned to respective pixels for visualization.

19. A computerized computer program product comprising a computer useable medium having computer readable program code embodied therein of volume rendering the computer program product comprising:
(a) computer readable program code for causing the computer to obtain volumetric data represented as a plurality of samples, each sample characterized by a value indicative of visual attributes of the sample and its position in a three-dimensional image space;
(b) computer readable program code for causing the computer to convert one or more samples to respective sets of two-dimensional elements at an image plane thus giving rise to a plurality of two-dimensional elements, each said element characterized by a shape, a size, a position at the image plane and a value indicative of visual attributes of the element and its depth order among the plurality of two-dimensional elements, said value calculated in accordance with the value indicative visual attributes of respective sample and its position in the three-dimensional image space; each said set of two-dimensional elements configured to cover a projection of respective sample to the image plane such that at least part of each element is positioned within a boundary of said projection, wherein the numbers of the elements in each said set are limited by certain maximal Nₘₐₓ and minimal Nₘᵢₙ numbers and wherein at least two two-dimensional elements among said plurality of two-dimensional elements and characterized by at least partly overlapping position at the image plane are generated with different size thus giving rise to different-resolution two-dimensional elements;
(c) computer readable program code for causing the computer to generate a data structure associated with the plurality of two-dimensional elements and configured to provide a relationship between said plurality and pixels in an image grid, wherein said data structure is configured to simultaneously hold data related to said different-resolution two-dimensional elements; and
(d) computer readable program code for causing the computer to process the data structure in accordance with certain sequence of associated two-dimensional elements in order to calculate values to be assigned to respective pixels for visualization.

20. A computerized method of volume rendering comprising
(a) obtaining volumetric data represented as a plurality of voxels;
(b) sampling the voxels at different resolutions corresponding to the limited number of two-dimensional elements per sample, thus giving rise to a plurality of different-resolution two-dimensional elements; and
(c) compositing the two-dimensional elements among said plurality of different-resolution two-dimensional elements in order to calculate values to be assigned to respective pixels for visualization.

21. The method of claim 20 wherein the compositing comprises generating a data structure associated with the plurality of different-resolution two-dimensional elements and configured to provide a relationship between said plurality and pixels in an image grid, wherein said data structure is configured to simultaneously hold data related to said different-resolution two-dimensional elements.
